(19) United States
(12) Patent Application Publication
(10) Pub. No.: US 2026/0135732 A1
(43) Pub. Date: May 14, 2026

(54) METHODS, APPARATUSES AND NON-TRANSITORY COMPUTER READABLE MEDIUMS ON THE SWITCHING CRITERIA FOR NON-PRIMARY CHANNEL ACCESS

(71) Applicant: Nokia Technologies OY, Espoo (FI)

(72) Inventors: Salvatore TALARICO, Los Gatos, CA (US); Klaus Franz DOPPLER, Albany, CA (US); Kerstin JOHNSSON, Palo Alto, CA (US); Prabodh VARSHNEY, Irving, TX (US); Orhan Okan MUTGAN, Munich (DE); Mario COSTA, Espoo (FI); Mika KASSLIN, Espoo (FI); Behnam DEZFOULI, San Jose, CA (US)

(73) Assignee: Nokia Technologies OY, Espoo (FI)

(21) Appl. No.: 18/943,204

(22) Filed: Nov. 11, 2024

(51) Int. Cl. H04L 12/64

(52) U.S. Cl. CPC H04L 12/6418; H04L 2012/6443

(57) ABSTRACT

A network apparatus for switching between a primary channel and an alternative primary channel of a plurality of channels allocated to a network of the network apparatus, comprising at least one processor; and at least one memory configured to store computer program code, the at least one processor, when executing the computer program code, is configured to cause the network apparatus to detect and decode packets received on the primary channel of the plurality of channels allocated to the network of the network apparatus, determine that the primary channel is busy in response to the detection and the decoding, and switch, in response to a switch event, to the alternative primary channel of the plurality of channels.

### BACKGROUND

When wideband transmission (or channel bonding) is used, a listen before talk (LBT) procedure is performed on each 20 MHz channel forming an overall bandwidth used in the transmission. One 20 MHz channel is selected as a primary channel. This channel is used as a reference channel to communicate control and management frames, as well as to support legacy Wi-Fi stations (STAs), while data frames are transmitted across the entire bandwidth (BW) by bonding the primary 20 MHz channel with all other available 20 MHz channels, which are called secondary channels. For an access point (AP) or non-AP Wi-Fi Station (STA) to acquire a transmission opportunity (TXOP) and perform a wideband transmission, the AP or non-AP STA has to first “win” the primary channel via an Enhanced Distributed Channel Access (EDCA) procedure regardless of whether the secondary channels are idle or not for which the STA will perform a separate check via a point coordination function (PCF) interframe space (PIFS) Clear Channel Assessment (CCA).

### SUMMARY

The scope of protection sought for various example embodiments of the present inventive concepts are set out by the independent claims. Some example embodiments and/or features, if any, described in this specification that do not fall under the scope of the independent claims are to be interpreted as examples useful for understanding various example embodiments.

One or more example embodiments provide methods, apparatuses, and/or non-transitory computer readable mediums on the switching criteria for non-primary channel access.

According to some example embodiments, a network apparatus for switching between a primary channel and an alternative primary channel of a plurality of channels allocated to a network of the network apparatus, may comprise at least one processor; and at least one memory configured to store computer program code, the at least one processor, when executing the computer program code, is configured to cause the network apparatus to, detect and decode packets received on the primary channel of the plurality of channels allocated to the network of the network apparatus; determine that the primary channel is busy in response to the detection and the decoding; and switch, in response to a switch event, to the alternative primary channel of the plurality of channels.

In some example embodiments, the switch event occurs in response to detecting a packet received on the primary channel and determining that decoding of the received packet is not possible.

In some example embodiments, the at least one processor is configured to cause the network apparatus to detect a packet received on the primary channel and decode the received packet; and the switch event occurs subsequent to the decoding of the received packet or in response to a determination that the received packet is from a separate network or a separate network apparatus.

In some example embodiments, the at least one processor is configured to cause the network apparatus to, detect and decode a packet received on the primary channel; determine whether the received packet includes an indication of a duration for which the primary channel is reserved for the packets received on the primary channel; and switch, in response to the switch event, to the alternative primary channel for the duration, the switch event occurring in response to the determination that the received packet includes the indication of the duration, or switch, in response to the switch event, to the alternative primary channel, the switch event occurring in response to the determination that the received packet does not include the indication of the duration and at an end of the received packet.

In some example embodiments the at least one processor is configured to cause the network apparatus to detect and decode a packet received on the primary channel, and the switch event occurs at an end of the received packet or after receiving an aggregated packet portion.

In some example embodiments, the at least one processor is configured to cause the network apparatus to detect and decode a packet received on the primary channel and determine whether the received packet includes an indication of a duration for which the primary channel is reserved for the packets received on the primary channel, and the switch event occurs, after the duration; after a control frame exchange; or after receiving a first aggregated data packet.

In some example embodiments, the at least one processor is configured to cause the network apparatus to, in response to detecting that the primary channel is busy, switch to the alternative primary channel in response to the switch event occurring, the switch event occurring in response to a determination that the network apparatus has utilized the primary channel for at least one second, or in response to a determination that a received packet overlaps with the primary channel, a duration for which the primary channel is reserved for the packets received on the primary channel is available, and the duration is shorter than a value.

According to some example embodiments, a method of operating a network apparatus for switching between a primary channel and an alternative primary channel of a plurality of channels allocated to a network of the network apparatus, comprises: detecting and decoding packets received on the primary channel of the plurality of channels allocated to the network of the network apparatus; determining that the primary channel is busy in response to the detection and the decoding; and switching, in response to a switch event, to the alternative primary channel of the plurality of channels.

In some example embodiments, the switch event occurs in response to a determination that decoding of a received packet is not possible, or in response to decoding the received packet and determining that the received packet is from a separate network or a separate network apparatus.

In some example embodiments, the method further includes determining whether a packet received on the primary channel includes an indication of a duration for which the primary channel is reserved for the packets received on the primary channel; and switching, in response to the switch event, to the alternative primary channel for the duration, the switch event occurring in response to the determination that the received packet includes the indication of the duration, or switching, in response to the switch event, to the alternative primary channel, the switch event occurring in response to the determination that the received packet does not include the indication of the duration and at an end of the received packet.

In some example embodiments, the method further includes determining whether a packet received on the primary channel includes an indication of a duration for which the primary channel is reserved for the packets received on the primary channel, and the switch event occurs, after the duration; after a control frame exchange; or after received a first aggregated data packet.

In some example embodiments, the method further includes, in response to the detecting that the primary channel is busy, switching to the alternative primary channel in response to the switch event occurring, the switch event occurring, in response to a determination that the network apparatus has utilized the primary channel for at least one second; or in response to a determination that a received packet overlaps with the primary channel, basic NAV information of the received packet is available, and a duration for which the primary channel is reserved for the packets received on the primary channel is shorter than a value.

In some example embodiments, a non-transitory computer readable medium comprising program instructions that, when executed by a network apparatus, is configured to cause the network apparatus to perform the method and/or operations according to any of the example embodiments described herein.

According to some example embodiments, a first network apparatus for switching between a primary channel and an alternative primary channel of a plurality of channels allocated to a network of the first network apparatus, comprises at least one processor; and at least one memory configured to store computer program code, the at least one processor, when executing computer program code, is configured to cause the first network apparatus to, communicate with a second network apparatus; detect and decode first packets received on the primary channel of the plurality of channels allocated to the network of the first network apparatus; determine first information of the first packets, the first information including at least a first identifier of the first packets and a first duration of time for which the first packets will overlap with the primary channel; receive, from the second network apparatus, second information of second packets received on the primary channel, the second information including at least a second identifier of the second packets and a second duration of time for which the second packets will overlap with the primary channel; and switch, in response to a first switch event, from the alternative primary channel to the primary channel of the plurality of channels.

In some example embodiments, the first switch event occurs based on the first identifier and the second identifier.

In some example embodiments, the at least one processor is configured to cause the first network apparatus to send the first information to the second network apparatus, and the first switch event occurs in response to the first identifier matching the second identifier, and subsequent to, the communication with the second network apparatus concluding, the first duration or the second duration expiring, or the communication with the second network apparatus concluding or the first duration or the second duration expiring, whichever occurs first.

In some example embodiments, the first switch event occurs in response to the first identifier being different than the second identifier, and subsequent to, the communication with the second network apparatus concluding, the first duration or the second duration expiring, or the communication with the second network apparatus concluding or the first duration or the second duration expiring, whichever occurs first.

In some example embodiments, the first switch event occurs, in response to the first identifier matching the second identifier and subsequent to the first duration or the second duration expiring; or in response to the first identifier being different than the second identifier and subsequent to both the first duration and the second duration expiring.

In some example embodiments, the first switch event occurs in response to the detecting of the second packets and at a completion of a data exchange with the second network apparatus.

In some example embodiments, the at least one processor is configured to cause the first network apparatus to receive from the second network apparatus an announcement frame, the announcement frame including at least, an element identifier identifying the announcement frame as a switching announcement frame; and a channel switch field indicating a switch to the primary channel or the alternative primary channel.

In some example embodiments, the first switch event occurs based on the received announcement frame.

According to some example embodiments, a first network apparatus for switching between a primary channel and an alternative channel of a plurality of channels allocated to a network of the first network apparatus, comprises at least one processor; and at least one memory configured to store computer program code, the at least one processor, when executing computer program code, is configured to cause the first network apparatus to, detect packets received on the primary channel of the plurality of channels allocated to the network of the first network apparatus; determine that the primary channel is busy in response to the detection; determine that decoding of a packet received on the primary channel is not possible; and switch, in response to a first switch event, from the alternative primary channel to the primary channel of the plurality of channels.

In some example embodiments, the first switch event occurs in response to, a duration for which the packets will overlap with the primary channel ending and a duration for which the packets will overlap with the alternative primary channel beginning; a completion of a data exchange on the alternative primary channel; or receiving an announcement frame from a second network apparatus.

In some example embodiments, the first switch event occurs in response to, detecting a duration for which the packets will overlap with the primary channel; and establishing communication with a second network apparatus, the second network apparatus having switched to the alternative primary channel.

In some example embodiments, the first switch event occurs in response to, determining that the detecting a duration for which the packets will overlap with the primary channel is not possible and that the decoding of a packet received on the primary channel is not possible; and continuing communication with a second network apparatus.

In some example embodiments, the first switch event occurs in response to, detecting a duration for which the packets will overlap with the primary channel; determining that decoding of a packet received on the primary channel is not possible; determining that communication with a second network apparatus is not possible; and a transmission of the first network apparatus ending.

According to some example embodiments, a method of operating a first network apparatus for switching between a primary channel and an alternative primary channel of a plurality of channels allocated to a network of the first network apparatus, comprises: detecting packets received on the primary channel of the plurality of channels allocated to the network of the first network apparatus; determining that the primary channel is busy in response to the detection; determining that decoding of a packet received on the primary channel is not possible; and switching, in response to a first switch event, from the alternative primary channel to the primary channel of the plurality of channels.

In some example embodiments, the first switch event occurs in response to, a duration for which the packets will overlap with the primary channel ending and a duration for which the packets will overlap with the alternative primary channel beginning; a completion of a data exchange on the alternative primary channel; or receiving an announcement frame from a second network apparatus.

In some example embodiments, the first switch event occurs in response to, detecting a duration for which the packets will overlap with the primary channel; establishing communication with a second network apparatus, the second network apparatus having switched to the alternative primary channel.

In some example embodiments, the first switch event occurs in response to, determining that the detecting a duration for which the packets will overlap with the primary channel is not possible and that the decoding of the packet received on the primary channel is not possible; and establishing communication with a second network apparatus.

In some example embodiments, the first switch event occurs in response to, detecting a duration for which the packets will overlap with the primary channel; determining that decoding of a packet received on the primary channel is not possible; determining that communication with a second network apparatus is not possible; and a transmission of the first network apparatus ending.

According to some example embodiments, a non-transitory computer readable medium comprising program instructions that, when executed by a network apparatus, is configured to cause the network apparatus to perform any of the methods and/or operations according to any of the example embodiments described herein.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limited of the present inventive concepts.

FIG. 1 illustrates a network apparatus according to some example embodiments.

FIG. 2 illustrates a network according to some example embodiments.

FIG. 3 illustrates an example where a transmission from a neighboring network apparatus or any other apparatus utilizing the same frequency carrier overlaps with a transmission from a reference network apparatus.

FIG. 4 illustrates an example where a transmission from a neighboring network apparatus or any other apparatus utilizing the same frequency carrier overlaps with a transmission from a reference network apparatus.

FIG. 5 illustrates an example where a transmission from a neighboring network apparatus or any other apparatus utilizing the same frequency carrier overlaps with a transmission from a reference network apparatus.

FIG. 6 illustrates an example of switching channels according to some example embodiments.

FIG. 7 illustrates an example of an OBSS transmission overlapping with a primary channel according to some example embodiments.

FIG. 8 illustrates an example of an OBSS transmission overlapping with a primary channel according to some example embodiments.

FIG. 9 illustrates an example of an OBSS transmission overlapping with a primary channel according to some example embodiments.

FIG. 10 illustrates a method of switching to an alternative primary channel according to some example embodiments.

FIG. 11 illustrates a method of switching to an alternative primary channel according to some example embodiments.

FIG. 12 illustrates a method of switching to a primary channel from an alternative primary channel according to some example embodiments.

FIG. 13 illustrates a method of switching to a primary channels from an alternative primary channel according to some example embodiments.

The various features and advantages of the non-limiting example embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

### DETAILED DESCRIPTION

Some detailed example embodiments are disclosed herein. However, specific structural and functional details disclosed herein are merely representative for purposes of describing some example embodiments thereof. Some example embodiments may, however, be embodied in many alternate forms and should not be construed as limited to only the example embodiments set forth herein.

Accordingly, while some example embodiments are capable of various modifications and alternative forms, some example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives thereof. Like numbers refer to like elements throughout the description of the figures.

The terminology used herein is for the purposes of describing the various example embodiments only and is not intended to be limiting of the various example embodiments. As used herein, the singular forms “a”, “an”, and “the” are intended to include the plural forms as well, unless the context clearly indicates otherwise. It will be further understood that the terms “includes”, “including”, “comprises”, and/or “comprising”, when used in this specification, specify the presence of stated features, integers, steps, operations, and/or elements, but do not preclude the presence or addition of one or more other features, integers, steps, operations, elements, and/or groups thereof.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

As described herein, any devices, electronic devices, modules, units, network devices, network apparatuses, access points, Wi-Fi stations, and/or portions thereof according to any of the example embodiments, and/or portions thereof may include, may be included in, and/or maybe implemented by one or more instances of processing circuitry such as hardware including logic circuits; hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, application-specific integrated circuit (ASIC), a neural network processing unit (NPU), an Electronic Control Unit (ECU), and the like. In some example embodiments, the processing circuitry may include a non-transitory computer readable storage medium or device (e.g., memory), for example a solid state drive (SSD), storing a program of instructions, and a processor (e.g., CPU) configured to execute the program of instructions to implement the functionality and/or methods performed by some or all of any devices, electronic devices, modules, units, network devices, network apparatuses, access points, Wi-Fi stations, and/or portions thereof according to any of the example embodiments.

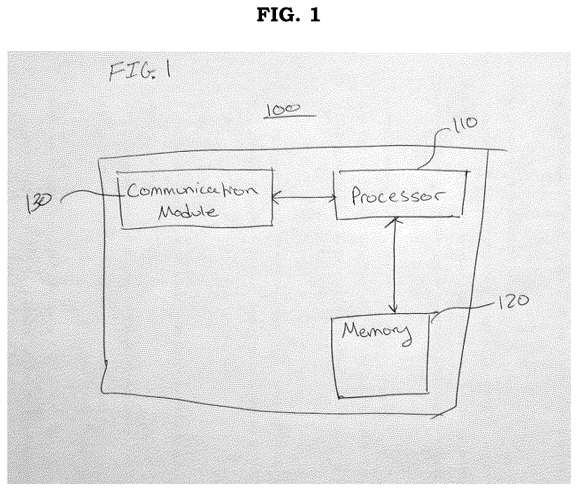

FIG. 1 illustrates a network apparatus according to some example embodiments.

Referring to FIG. 1, in some example embodiments a network apparatus 100 may include a processor 110, a memory 120, and a communication module 130.

According to some example embodiments, the memory 120 may be a non-transitory compute readable medium and may be configured to store a program of instructions. For example, the memory 120 may be a nonvolatile memory, such as a flash memory, a phase-change random access memory (PRAM), a magneto-resistive RAM (MRAM), a resistive RAM (reRAM), or a ferro-electric RAM (FRAM), or a volatile memory, such as a static RAM (SRAM), a dynamic RAM (DRAM), or a synchronous DRAM (SRAM).

According to some example embodiments, the communication module 130 may be implemented as one or more instances of processing circuitry. The communication module 130 may engage in one-way and/or two-way and/or broadcast communication with any or all other elements in the figures, to transfer and/or exchange and/or receive information such as but not limited to data and/or commands, in a manner such as in a serial and/or parallel manner, via a bus such as wireless and/or a wired bus.

In some example embodiments, the memory 120 may be configured to store a computer program or a program of instructions, and the processor 110 is configured to retrieve the computer program or the program of instructions from the memory 120 that, when executed by the processor 110, is configured to cause the network apparatus 100 and the communication module 130 of the network apparatus 100 to perform any of the methods, steps, operations, or functions according to any of the example embodiments described further below.

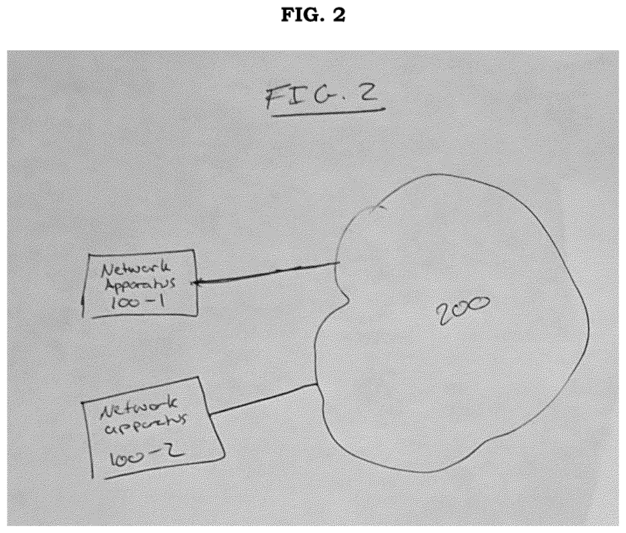

FIG. 2 illustrates a network according to some example embodiments.

Referring to FIG. 2, the network 200 may include network apparatuses 100-1 and 100-2 (e.g., a first network apparatus 100-1 and a second network apparatus 100-2) which have been connected to the network 200. For example, each of the first and second network apparatuses 100-1 and 100-2 has gained connectivity onto the network 200 through, for example, Wi-Fi.

According to some example embodiments, the first network apparatus 100-1 may be a non-AP network apparatus. For example, the first network apparatus 100-1 may be a non-AP Wi-Fi station (non-AP STA). In some example embodiments, the second network apparatus 100-2 may be an access point (AP) Wi-Fi station (STA).

According to some example embodiments, the first and second network apparatuses 100-1 and 100-2 may each be running latency-sensitive applications such as Virtual Reality, Mixed Reality and Augmented Reality (XR).

Referring to FIGS. 1 and 2, in some example embodiments, when wideband transmission (or channel bonding) is used, a listen before talk (LBT) procedure may be performed on each of the 20 MHz channels that may form an overall bandwidth used in the transmission. When operating in a wideband transmission mode, one of those 20 MHz channels is selected as a “primary channel.” For example, the primary channel is used as a reference channel to communicate control frames (e.g., control frames, selected control frames, etc.) and management frames such as request-to-send (RTS) and clear-to-send (CTS), as well as to support legacy network apparatuses or Wi-Fi stations (STAs), while data frames are transmitted or sent across the entire bandwidth (BW) by bonding the primary 20 MHz channel with all other available 20 MHz channels, which are called secondary channels. For example, in a wideband transmission mode in which 160 MHz bandwidth (BW) is available, the primary 20 MHz channel may be a “first” channel, while the remaining 20 MHz channels may be “second” to “eighth” channels. For example, the first channel may be referred to as the “primary” channel, whereas the remaining channels may be referred to as “secondary” channels.

According to some example embodiments, for a network apparatus, e.g., the second network apparatus 100-2 (or a AP STA or non-AP STA), to acquire a transmission opportunity (TXOP) and perform a wideband transmission, the second network apparatus 100-2 has to first “win” the primary channel via the Enhanced Distributed Channel Access (EDCA) procedure regardless of whether the secondary channels are idle or not for which the second network apparatus 100-2 will perform a separate check via a PCF interframe space (PIFS) Clear Channel Assessment (CCA). For example, the first and/or second network apparatus 100-1 or 100-2 may receive and/or acquire the TXOP by an RTS and CTS frame exchange. In some example embodiments, TXOP may refer to a time-based access mechanism utilized in wireless networks, for example, in the IEEE 802.11 standard. For example, during TXOP a device (e.g., the second network apparatus 100-2) has exclusive access to the wireless medium (e.g., the network 200), allowing the second network apparatus 100-2 to transmit or send data without contention from other devices or network apparatuses. For example, the TXOP may be defined by a specific, or alternatively desired time period during which the second network apparatus 100-2 may transmit or send multiple frames or packets.

For example, in 802.11ac, this procedure was enhanced to allow a network apparatus (e.g., second network apparatus 100-2) to adjust its transmission bandwidth per TXOP to 20 MHz, 40 MHz, 80 MHz or 160 MHz, based on channel availability, as long as the resulting bandwidth was contiguous in one or multiple blocks of 20 MHz channels, and the primary channel was assessed to be idle. These limitations resulted in a significant amount of unused spectrum, as many available, but non-contiguous 20 MHz channels ended up sitting idle while they could not be used.

802.11ax and 802.11be introduced the concept of preamble puncturing, which allows a STA to create bandwidth out of non-contiguous idle (i.e., CCA clear) channels. However, the STA still had to first capture the primary 20 MHz channel via EDCA. Given the ever-increasing amount of spectrum available for 802.11 transmissions, the operation to capture the primary 20 MHz channel often left large or larger chunks of spectrum unused. Thus, the primary channel could be interpreted to represent a bottleneck in terms of system performance and spectrum utilization.

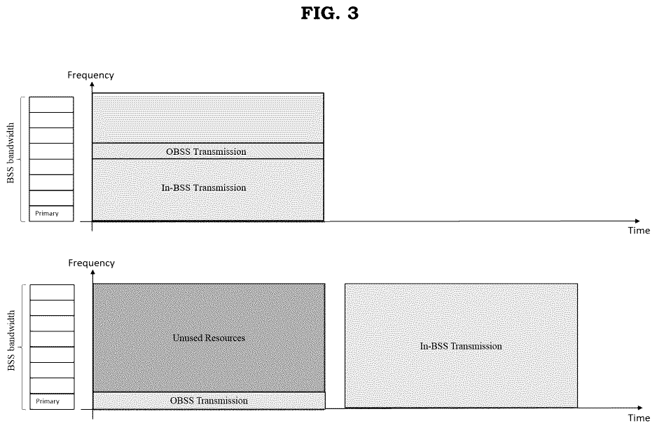

FIG. 3 illustrates an example where a transmission from a neighboring network apparatus or any other apparatus utilizing the same frequency carrier overlaps with a transmission from a reference network apparatus.

Referring to FIG. 3, a 20 MHz transmission from a neighboring AP/non-AP STAs or any other devices utilizing the same frequency carrier may overlap with a reference 160 MHz transmission from a reference non-AP/AP STA (e.g., a first/second network apparatus 100-1 and 100-2). For example, the transmission from the neighboring AP/non-AP STAs may be referred to as an overlapping basic service set (OBSS) transmission. For example, the transmission from the reference AP (e.g., second network apparatus 100-2) or non-AP STA (e.g., first network apparatus 100-1) may be referred to as an In-BSS transmission. An In-BSS transmission may mean that data transmissions occur between network apparatuses (e.g., network apparatuses 100-1 and 100-2), devices, or AP/non-AP STAs that are part of the same basic service set (BSS) or between multiple non-AP STAs in peer-to-peer communication. For example, referring to FIG. 2, if network apparatus 100-1 connected to network apparatus 100-2 are communicating, this may be considered an In-BSS transmission.

Still referring to FIG. 3, the top sub-figure illustrates an example where an OBSS transmission overlaps one of the reference secondary channels. In this example, puncturing is applied, removing the 20 MHz channel used by the OBSS from the reference transmission BW, and the reference In-BSS transmission proceeds over a reduced BW.

The bottom sub-figure of FIG. 3 illustrates an example where an OBSS transmission overlaps the reference primary 20 MHz channel. In this example, In-BSS transmission may be deferred, since the primary channel is busy. As a result, all but the first 20 MHz (e.g., used by the OBSS) may sit idle until the primary channel is free again.

Accordingly, due to the above, it may be advantageous for current Wi-Fi deployments to be carefully or more carefully provisioned and planned, assigning neighboring BSSs orthogonal primary channels and often precluding high bandwidth (BW) support (for example, as they may overlap a neighbor's primary channel). Thus, resulting in inefficient use of spectrum resources and lower effective system throughput compared to what can and/or could be supported.

Additionally, in some example embodiments, inefficiencies in spectrum usage and lower effective system throughput may be exacerbated or increased by the fact that the maximum operating bandwidth increases roughly with every Wi-Fi generation. For example, channel bonding was introduced in 802.11n, allowing transmissions over contiguous 40 MHz. This was extended to 80 MHz and 160 MHz in 802.11ac. For example, 802.11be now supports 320 MHz.

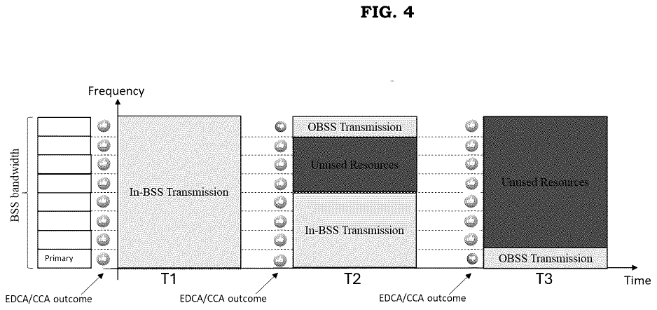

FIG. 4 illustrates an example where a transmission from a neighboring network apparatus or any other apparatus utilizing the same frequency carrier overlaps with a transmission from a reference network apparatus.

Referring to FIG. 4, FIG. 4 illustrates an example of how a BSS behaves in 802.11ac in the presence of OBSS transmissions. For example, in a first transmission period T1, there is no OBSS transmission, thus the BSS transmits or sends over the entire 160 MHz channel. In a second transmission period T2, there is an OBSS transmission in the last 20 MHz of the 160 MHz channel. For example, since 802.11ac limits or reduces transmission to contiguous 20/40/80/160 MHz channels with an option to split 160 MHz in two blocks of contiguous 80 MHz, and the OBSS is utilizing a portion of the 160 MHz channel, the BSS is restricted to the first contiguous 80 MHz. Thus, 60 MHz are idle and/or unused. In the third transmission period T3, the OBSS is utilizing the first 20 MHz, which collides with the primary channel, thus the BSS may not transmit or send whatsoever, and therefore 140 MHz goes unused.

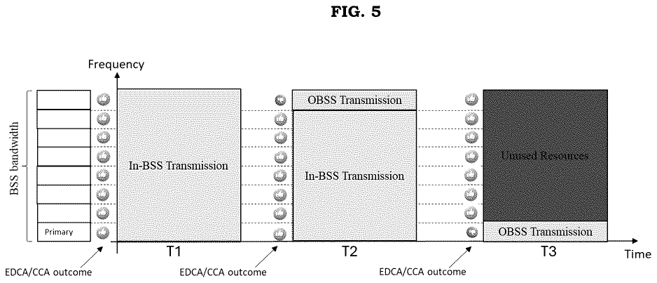

FIG. 5 illustrates an example where a transmission from a neighboring network apparatus or any other apparatus utilizing the same frequency carrier overlaps with a transmission from a reference network apparatus.

Referring to FIG. 5, in some example embodiments, in a first transmission period T1, there is no OBSS transmission, thus as mentioned with reference to FIG. 4, the BSS transmits or sends over the entire 160 MHz bandwidth. In the second transmission period T2, there is an OBSS transmission in the last 20 MHz of the 160 MHz bandwidth. The BSS can transmit or send over the first 140 MHz, leaving the last 20 MHz to the OBSS via preamble puncturing. Thus, no spectrum goes unused. However, as illustrated in FIG. 5, in the third transmission period T3, the OBSS is using the first 20 MHz, which is the BSS's primary channel. Accordingly, the BSS may not transmit or send anything, leaving 140 MHz unused.

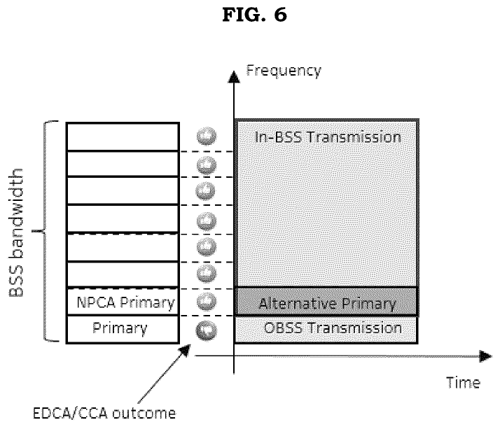

FIG. 6 illustrates an example of switching channels according to some example embodiments.

Referring to FIG. 6, in some example embodiments a network apparatus (e.g., network apparatus 100-1 or 100-2) is configured to detect packets on a primary channel of a plurality of channels allocated to the network apparatus 100-1 or 100-2.

For example, the network apparatus 100-1 or 100-2 may be able to detect packets on a primary channel, the packets may be an OBSS transmission. For example, the network apparatus 100-1 or 100-2 may be able to detect the transmission from a neighboring AP/non-AP STAs that is overlapping the primary channel.

In some example embodiments, in response to detecting the OBSS transmission from the neighboring AP/non-AP STAs that is overlapping the primary channel, the network apparatus 100-1 or 100-2 is configured to switch to an alternative primary channel of the plurality of channels allocated to the network apparatus 100-1 or 100-2. For example, when the OBSS transmission is detected on the primary channel of the plurality of channels allocated to the network apparatus 100-1 or 100-2, the network apparatus 100-1 or 100-2 is configured to switch to a, for example, 20 MHz secondary channel (e.g., non-primary channel access (NPCA)). For example, the network apparatus 100-1 or 100-2 may be configured to temporarily utilize an idle alternative (e.g., secondary) channel as a primary channel. In some example embodiments, the alternative primary channel may be referred to as a NPCA primary channel.

According to some example embodiments, depending on, for example, the Wi-Fi deployment, there may be scenarios where there may be ambiguity between an AP (e.g., network apparatus 100-2) and an associated STA (e.g., network apparatus 100-1) on whether the primary channel should be used (e.g., the AP (e.g., network apparatus 100-2) hears OBSS traffic on the primary channel above some pre-defined, or alternatively desired level, while the STA (e.g., network apparatus 100-1) does not). Similarly, for example, once an AP (e.g., network apparatus 100-2) and an associated STA (e.g., network apparatus 100-1) move or switch to an alternative primary channel (e.g., NPCA primary channel), there may be ambiguity between the AP (e.g., network apparatus 100-2) and the associated STA (e.g., network apparatus 100-1) regarding whether/when to return or switch back to the primary channel.

For example, an AP (e.g., network apparatus 100-2) may move or switch the alternative primary channel (NPCA primary channel), while an STA (e.g., network apparatus 100-1) associated with the AP (e.g., network apparatus 100-2) does not or vice versa, causing an interruption in their communication and loss of connectivity.

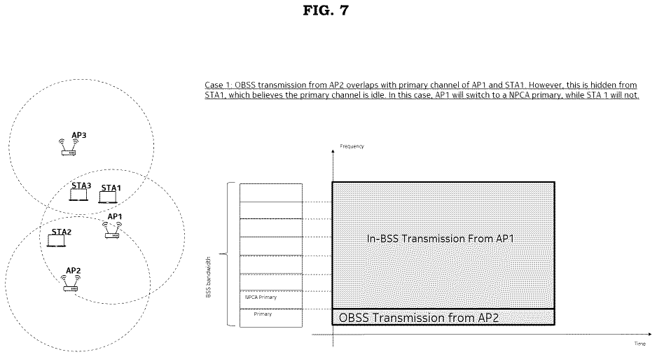

FIG. 7 illustrates an example of an OBSS transmission overlapping with a primary channel.

Referring to FIG. 7, in some example embodiments, a transmission from a neighboring access point AP2 (e.g., second AP) overlaps with the primary channel utilized by a reference access point AP1 (e.g., first AP, or second network apparatus 100-2) and the reference access point's AP1 associated non-AP STA (e.g., STA1, first STA, or first network apparatus 100-1). For example, since the transmission from AP2 is hidden from STA1 (e.g., first network apparatus 100-1), AP1 (e.g., second network apparatus 100-2) by detecting that the primary channel is busy due to overlapping transmission with AP2 may switch to the alternative primary channel (e.g., NPCA primary channel), while STA1 (e.g., first network apparatus 100-1) may remain on the primary channel since STA1 (e.g., first network apparatus 100-1) may not detect any OBSS transmissions. For example, AP1 (e.g., second network apparatus 100-2) may detect a transmission or packets from AP2 on AP1's (e.g., second network apparatus 100-2) primary channel, thus AP1 (e.g., second network apparatus 100-2) may switch to the alternative primary channel (e.g., NPCA primary channel). However, STA1 (e.g., first network apparatus 100-1) may not detect the transmission or packets from AP2 on the primary channel, and may, for example, remain on the primary channel.

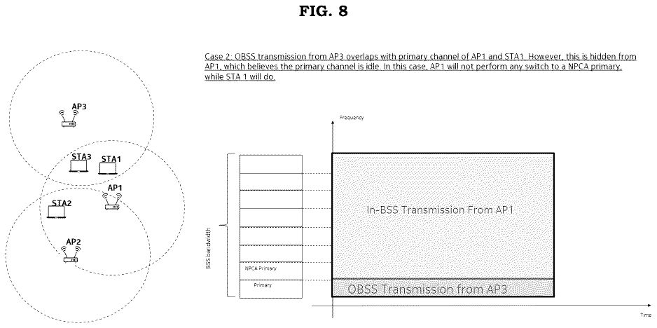

FIG. 8 illustrates an example of an OBSS transmission overlapping with a primary channel.

Referring to FIG. 8, in some example embodiments, a STA (e.g., first network apparatus 100-1) may detect an OBSS transmission, but the STA's (e.g., first network apparatus 100-1) associated AP (e.g., second network apparatus 100-2) may not detect the OBSS transmission. For example, an access point AP3's (e.g., third access point) transmission may overlap the primary channel of AP1 (e.g., second network apparatus 100-2) and STA1 (e.g., first network apparatus 100-1). STA1 (e.g., first network apparatus 100-1) may detect AP3's transmission, while AP1 (e.g., second network apparatus 100-2) does not. Thus, STA1 (e.g., first network apparatus 100-1) may move or switch to the alternative primary channel (e.g., NPCA primary channel), while AP1 (e.g., second network apparatus 100-2) remains on the primary channel, causing a disruption in the communications between AP1 and STA1 (e.g., network apparatuses 100-2 and 100-1).

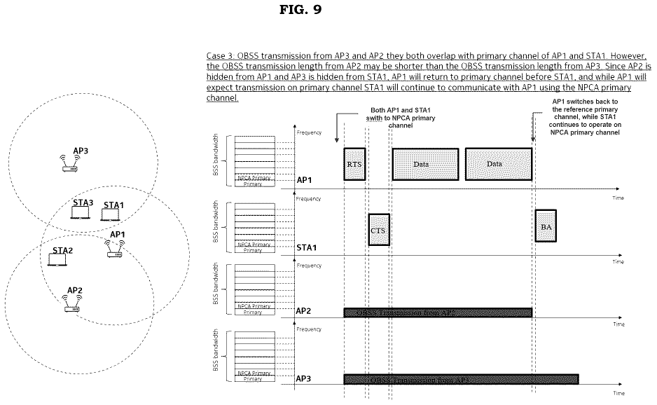

FIG. 9 illustrates an example of an OBSS transmission overlapping with a primary channel.

Referring to FIG. 9, in some example embodiments, an STA (e.g., first network apparatus 100-1) may detect a first OBSS transmission, and an access point AP (e.g., second network apparatus 100-2) associated with the STA (e.g., first network apparatus 100-1) may detect a second OBSS transmission different than the first OBSS transmission. For example, the AP (e.g., second network apparatus 100-2) and the STA (e.g., first network apparatus 100-1) associated with the AP (e.g., second network apparatus 100-1) may detect different OBSS transmissions overlapping the primary channel with different transmission lengths, causing the AP (e.g., second network apparatus 100-2) and the STA (e.g., first network apparatus 100-1) associated with the AP (e.g., second network apparatus 100-2) to return or switch to their primary channel at different times (e.g., at different points in time).

For example, referring to FIG. 9, an OBSS transmission from AP3 (e.g., third AP) and AP2 (e.g., second AP) may both overlap with the primary channel utilized by AP1 (e.g., first AP or second network apparatus 100-2) and STA1 (e.g., first STA or first network apparatus 100-1) associated with AP1. However, in this example, the OBSS transmission from AP2 (e.g., second AP) may be hidden from AP1 (e.g., first AP), and the OBSS transmission from AP3 (e.g., third AP) may be hidden from STA1 (e.g., first STA). Thus, in some example embodiments, even if both AP1 (e.g., first AP) and AP1's associated STA (e.g., first STA) sense and/or detect that their primary channel is to be occupied by an OBSS transmission, the OBSS transmission that causes such occupation (e.g., overlap of the primary channel) may be different. For example, the OBSS transmission from AP2 (e.g., second AP) and the OBSS transmission from AP3 (e.g., third AP) may be of different lengths. Thus, both AP1 and AP1's associated STA1 may move or switch to the alternative primary channel (e.g., NPCA primary channel) at a same time, but AP1 and STA1 may return or switch back to their primary channel at different times (e.g., at different points in time). Accordingly, disruptions in communications between AP1 and STA1 may occur, and, in some example embodiments, the switch at different time points by AP1 and STA1 may prevent a Block Acknowledgement transmitted or sent by STA1 from being received by AP1, which may cause STA1 to re-send or re-transmit the Block Acknowledgement.

According to some example embodiments, a Block Acknowledgement may be utilized by, for example, STA1 to acknowledge reception of data frames. For example, instead of sending or transmitting an individual acknowledgement (ACK) for each data frame received, STA1 may utilize a block acknowledgement (BA) which may allow STA1 to acknowledge multiple data frames that are received in a single block acknowledgement (BA) frame.

Accordingly, some example embodiments of the present inventive concepts may mitigate or reduce the above disruptions in communications and may harmonize or coordinate the switch from a primary channel to an alternative primary channel (e.g., NCPA channel), and the switch back from the alternative primary channel (e.g., NCPA channel) to the primary channel.

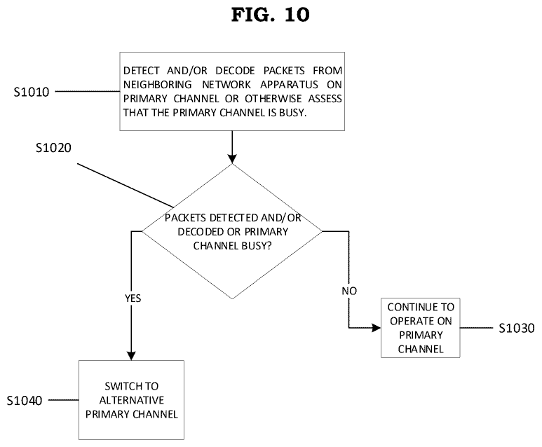

FIG. 10 illustrates a method of switching to an alternative primary channel according to some example embodiments.

Referring to FIG. 10, at operation S1010, the network apparatus 100-1 or 100-2 may detect and decode packets on a primary channel of a plurality of channels allocated to the network apparatus 100-1 or 100-2, or otherwise assess that the primary channel is busy. For example, the network apparatus 100-2 and the network apparatus's 100-2 associated network apparatus 100-1 may detect packets on the primary channel. For example, an access point (e.g., network apparatus 100-2) and the access point's associated STA (e.g., network apparatus 100-1) may detect and decode an OBSS transmission on their primary channel or otherwise assess that their primary channel is busy.

At operation S1020, the network apparatus 100-1 or 100-2 may determine that packets from a neighboring network apparatus are detected and/or decoded or may alternatively determine that the primary channel is busy.

For example, at operation S1030, in response to not detecting packets on the primary channel or otherwise determining that the primary channel is not busy, network apparatus 100-1 or 100-2 may continue to operate and/or communicate on the primary channel.

For example, at operation S1040, in response to detecting and/or decoding packets on the primary channel or otherwise determining that the primary channel is busy, network apparatus 100-1 or 100-2 may switch to the alternative primary channel (e.g., NPCA primary channel). For example, the detecting and/or decoding packets on the primary channel may be referred to as a switch event. Thus, in some example embodiments, the network apparatuses 100-1 or 100-2 may switch to the alternative primary channel in response to an occurrence of a switch event (e.g., the detecting and/or decoding of packets received on the primary channel).

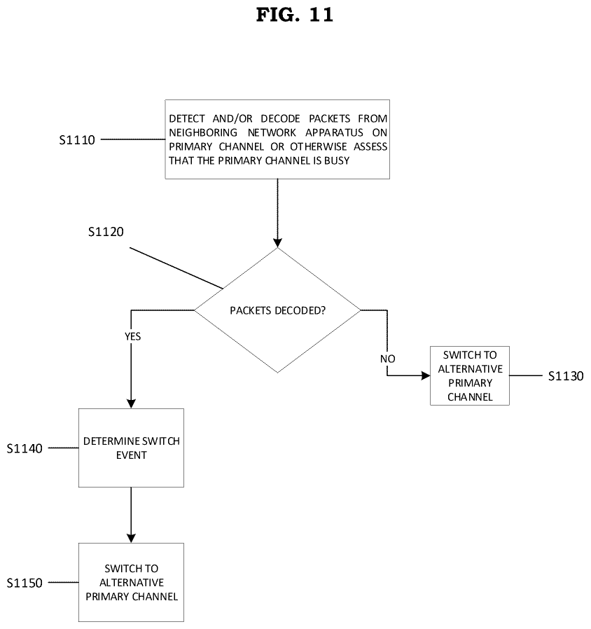

FIG. 11 illustrates a method of switching to an alternative primary channel according to some example embodiments.

Referring to FIG. 11, at operation S1110, network apparatus 100-1 or 100-2 detects and/or decodes packets received on the primary channel of the plurality of channels allocated to the network apparatus 100-1 or 100-2, or otherwise assesses that the primary channel is busy. For example, the network apparatus 100-1 or 100-2 may determine that the primary channel is busy in response to the detection and/or decoding.

At operation S1120, network apparatus 100-1 or 100-2 determines whether decoding of a packet received or detected on the primary channel is possible. For example, the packets on the primary channel may be an OBSS transmission from a neighboring network apparatus. For example, while the packets are overlapping the primary channel, a received packet or a detected packet of the packets on, or received on, the primary channel may be a data packet, or a frame received from the neighboring network apparatus that overlaps the primary channel. For example, at operation S1120, when the network apparatus 100-1 or 100-2 detects the packets on the primary channel and assesses the primary channel to be busy, the network apparatus 100-1 or 100-2, at operation S1120, may attempt to decode the packet. The packet may be, for example, an overlapping basic service set physical layer protocol data unit (OBSS PPDU). For example, the OBSS PPDU may be considered a single packet among the detected packets. In some example embodiments, the term “OBSS PPDU” may refer to one frame transmitted or sent by the neighboring apparatus or an overlapping basic service set (BSS).

At operation S1130, if the network apparatus 100-1 or 100-2 cannot decode the packet, or determines that the decoding of the packet is not possible, the network apparatus 100-1 or 100-2 may switch to the alternative primary channel (e.g., NPCA primary channel). For example, the network apparatus 100-1 or 100-2 may immediately switch to the alternative primary channel upon determining the decoding of the packet is not possible. In some example embodiments, the network apparatus 100-1 or 100-2 may switch to the alternative primary channel subsequent to determining that the decoding of the packet is not possible. In some example embodiments, the network apparatus 100-1 or 100-2 may switch to the alternative primary channel after some margin or period of time. For example, the network apparatus 100-1 or 100-2 may switch to the alternative primary channel 1 s, 1 ms, or 1 us after determining that decoding of the packet is not possible. In some example embodiments, the network apparatus 100-1 or 100-2 may switch to the alternative primary channel using a duration of SIFS (short interframe space). For example, SIFS may be a shortest interframe space. The duration of SIFS may be 10 microseconds, 16 microseconds, 160 microseconds, 3 microseconds, etc., but example embodiments are not limited thereto. In some example embodiments, the network apparatus 100-1 or 100-2 may switch to the alternative primary channel at a point coordination function interframe space (PIFS) level. For example, the network apparatus 100-1 or 100-2 may switch to the alternative primary channel in units of a slot (e.g., 9 us), in units of a SIFS (e.g., 16 us), or in units of a PIFS (25 us). According to some example embodiments, each of the above described events and/or conditions may be considered as a switch event. For example, the network apparatus 100-1 or 100-2 may switch, in response to a switch event, to the alternative primary channel of the plurality of channels. For example, the switch event may occur in response to a determination that decoding of a packet received on the primary channel is not possible. In some example embodiments, the switch event may occur subsequent to decoding of the received packet or in response to a determination that the received packet is from a separate network or a separate network apparatus.

In some example embodiments, if the network apparatus 100-1 or 100-2 determines that the packet can be decoded, or determines that the decoding of the packet is possible, at operation S1140, the network apparatus 100-1 or 100-2 determines when to switch to the alternative primary channel based on the decoding. In some example embodiments, the network apparatus 100-1 or 100-2 may determine a switch event or a switching event for switching to the alternative primary channel.

At operation S1150, the network apparatus 100-1 or 100-2 may switch to the alternative primary channel based on the determination at operation S1140.

According to some example embodiments, the switch time to the alternative primary channel (e.g., NPCA primary channel) may occur based on a type of packet that has been received or detected. For example, the switch time may occur based on the type of OBSS PPDU that is received or detected.

According to some example embodiments, for high efficiency (HE) PPDU's and newer PPDUs, the network apparatus 100-1 or 100-2 may switch to the alternative primary channel (e.g., NPCA primary channel) after decoding a HE-SIG-A or U-SIG respectively. For example, HE-SIG-A may be a high efficiency signal A field used in 802.11ax. The HE-SIG-A field may contain information about the packet, such as a Modulation and Coding Scheme (MCS), bandwidth, spatial streams, BSS color, and the remaining time in a transmit opportunity (TXOP). For example, the U-SIG may refer to a Universal Signal field.

According to some example embodiments, for very high throughput (VHT) PPDUs and high throughput (HT) PPDUs, the network apparatus 100-1 or 100-2 may switch to the alternative primary channel (e.g., NPCA primary channel) after validating header information, such as a MAC header, of the PPDU. For example, the network apparatus 100-1 or 100-2, based on the validating the header information of the packet, may determine that the PPDU is from an OBSS (e.g., a neighboring network apparatus). The network apparatus 100-1 or 100-2 may then switch to the alternative primary channel after, immediately after, or subsequent to validating that the PPDU is from an OBSS (e.g., neighboring network apparatus).

In some example embodiments, the header information of the packet may be MAC header information of the PPDU. For example, the MAC header may contain information about the packet (e.g., frame), including the BSS (Basic Service Set) identifier and TXOP (Transmit Opportunity) details. The BSS identifier may indicate to the network apparatus 100-1 or 100-2 whether the PPDU belongs to the same BSS as the network apparatus 100-1 or 100-2 (e.g., whether the PPDU belongs to the network of the network apparatus 100-1 or 100-2) or whether the PPDU belongs to an overlapping basic service set identifier (OBSS). The TXOP may indicate a duration for which the neighboring network apparatus (e.g., transmitting STA) has the right to use the primary channel (e.g., the medium). In some example embodiments, the TXOP may indicate a duration for which the primary channel is reserved by the OBSS.

In some example embodiments, when the network apparatus 100-1 or 100-2 (e.g., STA) receives a VHT or HT PPDU, the network apparatus 100-1 or 100-2 may validate the MAC header to determine if the PPDU is from an OBSS. For example, the network apparatus 100-1 or 100-2 may check that the BSS identifier, and determine that the PPDU is from an OBSS. The network apparatus 100-1 or 100-2 may then switch to the alternative primary channel after checking the MAC header and determining that the PPDU is from the OBSS.

In some example embodiments, the network apparatus 100-1 (e.g., STA) or 100-2 (e.g., AP) may switch to the alternative primary channel after an end of a first (A-)MPDU. For example, the (A-)MPDU (Aggregated MAC Protocol Data Unit) may be a portion of the OBSS PPDU. The PPDU may be a complete packet or data packet received by the network apparatus 100-1 or 100-2 on the primary channel. The OBSS PPDU or a PPDU may include a preamble, header, and data fields. For example, the data field of a PPDU can contain one or more MPDUs (MAC Protocol Data Units). In some example embodiments, if the OBSS PPDU that is received or detected on the primary channel contains an A-MPDU, then the network apparatus 100-1 or 100-2 may switch to the alternative primary channel at the end of the first A-MPDU.

According to some example embodiments, for non-HT PPDUs, when the network apparatus 100-1 or 100-2 switches to the alternative primary channel depends on whether the PPDU carries an (MU-)RTS. For example, the (MU-)RTS frame may contain or include details or information about a duration of the transmission or the TXOP and the BSS identifier.

For example, if the non-HT PPDU carries the (MU-)RTS frame, the switch to the alternative primary channel occurs after a set duration which may be based on Network Allocation Vector (NAV) information (e.g., the switch can be based on the basic NAV information, and network apparatus (e.g., STAs) may need to switch after receiving the responding frame (CTS) or frame followed by the responding frame (e.g., Data Frame). However, some network apparatuses (e.g., STAs or network apparatuses 100-1 and 100-2) may not hear or detect the CTS but may hear or detect the data frame causing ambiguity across STAs (e.g., network apparatuses 100-1 and 100-2), which may lead to switching at different instances of time.

For example, if the non-HT PPDU does not carry an (MU-)RTS frame, the switch to the alternative primary channel may occur at an end of the non-HT PDDU, for example if the non-HT PPDU carries an (MU-)CTS frame.

According to some example embodiments, the network apparatus 100-1 or 100-2 may move or switch to the alternative primary channel (e.g., NPCA primary channel) at an end of a received OBSS PPDU, regardless of the OBSS PPDU type. In some example embodiment the network apparatus 100-1 or 100-2 may move or switch to the alternative primary channel after an L-SIG (e.g., legacy signal) is decoded. In some example embodiments, the network apparatus 100-1 or 100-2 may switch to the alternative primary channel after receiving the MAC header or after validating the duration field of the NAV in the MAC header. In some example embodiments, if a received PPDU contains an (MU-)RTS, one of the following switching events may apply: network apparatus 100-1 (e.g., STA) or 100-2 (e.g., AP) moves or switches to the alternative primary channel after the NAVtimeout; network apparatus 100-1 (e.g., STA) or 100-2 (e.g., AP) switches to the alternative primary channel after the network apparatus 100-1 or 100-2 and/or after it receives a CTS (e.g., after control frame exchange), which may confirm the basic NAV set after the CTS; or network apparatus 100-1 (e.g., STA) or 100-2 (e.g., AP) moves or switches to the alternative primary channel after successfully receiving the first data MPDU (potentially from an A-MPDU) or after successfully decoding the MAC header of the first data MPDU.

According to some example embodiments, upon detecting and/or decoding packets received on the primary channel, and in response to determining that the primary channel is busy based on the detecting and/or the decoding, the network apparatus 100-1 or 100-2 may determine to switch to the alternative primary channel (e.g., NPCA primary channel) based on an occurrence of an event or based on a condition. For example, the network apparatus 100-1 or 100-2 may determine to switch to the alternative primary channel based on, or in response to, an occurrence of a switch event. For example, the switch may occur if the network apparatus 100-1 or 100-2 has been utilizing the primary channel for at least T seconds, where, for example, T=1 s. In some example embodiments, a timer may be defined, and the timer may count the time incurring from when the network apparatus 100-1 or 100-2 (e.g., the STA or the AP) switches from an alternative primary channel to a primary channel. For example, once the time expires the network apparatus 100-1 or 100-2 may switch back to the alternative primary channel if the primary channel is busy. For example, the timer may be configured to count the time between an end of a last frame received or transmitted or sent which is addressed to the network apparatus 100-1 or 100-2 into the alternative primary channel before switching to a primary channel, and the network apparatus 100-1 or 100-2 may be permitted to switch, or may switch, back to the alternative primary channel when the timer elapses. For example, the counter may count from an end of a TXOPs in which the network apparatus 100-1 or 100-2 (e.g., the STA or the AP) has received or transmitted or sent a last frame addressed to itself into the alternative primary channel before switching to the primary channel, and the network apparatus 100-1 or 100-2 may be permitted to switch, or may switch, back to the alternative primary channel upon the counter reaching a certain, or alternative desired value. The counter may count from a time that the network apparatus 100-1 or 100-2 switches to the alternative primary channel. In some example embodiments, the timer may be combined with any other switch event, condition, and/or rule defined in any of the example embodiments.

In some example embodiments, when an OBSS transmission overlaps with the primary channel, the basic NAV from the OBSS transmission is available, and a length or duration of the OBSS transmission is shorter than a predefined, preconfigured, or alternatively desired value, no channel switch may occur. For example, no channel switching may occur for power saving purposes as switching to an alternative primary channel (e.g., NPCA primary channel) may consume power or increase a consumption of power by the network apparatus 100-1 or 100-2.

In some example embodiments, when the network apparatus 100-1 or 100-2 intends to transmit, send, or communicate on the alternative primary channel, but during a medium or channel synchronization process or while performing a backoff to acquire a TXOP using the alternative primary channel, the network apparatus 100-1 or 100-2 may receive a PPDU from an OBSS or the network apparatus 100-1 or 100-2 may find that the medium or channel is occupied (e.g., busy), and the network apparatus 100-1 or 100-2 may return or switch to the primary channel immediately if a length or duration of the OBSS PPDU is larger than “X” micro seconds, where X could include X=0, or prolongs past the OBSS transmission occurring on the primary channel or both. In some example embodiments, given that a network apparatus 100-1 or 100-2 (e.g., the STA or the AP) may have information related to a basic NAV or PPDU duration in the alternative primary channel, the network apparatus 100-1 or 100-2 may ignore this information when switching back to the primary channel if the alternative primary channel is being utilized as a secondary channel and a received power for that channel is less than −72 dBm. For example, regardless of the NAV and PPDU duration in the alternative primary channel, a transmission may occur overlapping this channel if the channel access procedure succeeds on the primary channel.

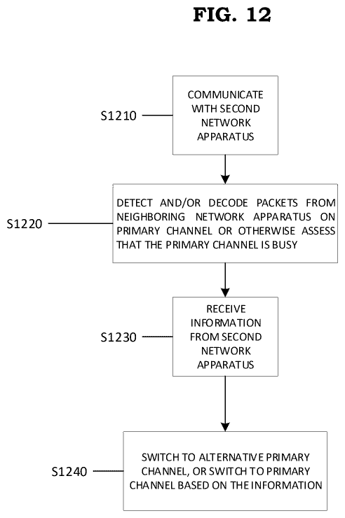

FIG. 12 illustrates a method of switching to a primary channel from an alternative primary channel according to some example embodiments.

Referring to FIG. 12, at operation S1210, a first network apparatus 100-1 may communicate with a second network apparatus 100-2. At operation S1220, the first network apparatus 100-1 may detect and/or decode first packets received on a primary channel of a plurality of channels allocated to the network of the first network apparatus 100-1. In some example embodiments, the first network apparatus 100-1 may determine first information of the first packets. For example, the first information may include at least a first identifier of the first packets and a first duration of time for which the first packets will overlap the primary channel, but example embodiments are not limited thereto and the first network apparatus 100-1 may determine other information.

At operation, S1230, the first network apparatus 100-1 may receive from a second network apparatus 100-2, second information. In some example embodiments, the second information may include at least an identifier of the second packets and a second duration of time for which the second packets may overlap with the primary channel. The second information may be information that is detected and/or decoded by the second network apparatus 100-2. For example, the second network apparatus 100-2 may be on a same network as the first network apparatus 100-1.

For example, upon switching to the alternative primary channel, the second network apparatus 100-2 may transmit or send to the first network apparatus 100-1 information. The second network apparatus 100-2 may be an access point (AP) and the first network apparatus 100-1 may be an STA. The following description will refer to the first network apparatus 100-1 as a non-AP STA (e.g., a non-AP Wi-Fi station), and the second network apparatus 100-2 as an AP STA, but such terms are merely used for ease of description, and are not intended to limit the example embodiments of the present inventive concepts.

For example, at operation S1230, the STA (e.g., first network apparatus 100-1) may receive from the AP (e.g., second network apparatus 100-2) second information of second packets overlapping and/or occupying the primary channel or the second information may include the TXOP duration occupying the primary channel. For example, the second information may include at least a second identifier of the second packets and a second duration of time for which the second packets will overlap the primary channel. For example, the AP (e.g., second network apparatus 100-2) may transmit or sent to the STA (e.g., first network apparatus 100-1), and the STA (e.g., first network apparatus 100-1) may receive from the AP (e.g., second network apparatus 100-2), an AP_OBSSID and AP_OBSS_Basic_NAV_Timer. The AP_OBSSID may refer to the identifier (e.g., BSSID) of the OBSS overlapping with the primary channel that is detected and/or decoded by the AP (e.g., second network apparatus 100-2). The AP_OBSS_Basic_NAV_Timer may be basic NAV timer information of the OBSS overlapping with the primary channel detected and/or decoded by the AP (e.g., second network apparatus 100-2).

According to some example embodiments, the information transmitted or sent by the AP (e.g., second network apparatus 100-2) and received by the STA (e.g., first network apparatus 100-1) may be carried, or included, within a dedicated information element or field information inside a control frame (e.g., an enhanced RTS or MU-RTS, or an action frame, or any other existing or new dedicated frames) or as part of a data transmission carried in a UHR PPDU (ultra-high reliability physical protocol data unit).

In some example embodiments, the STA (e.g., first network apparatus 100-1), in response to receiving the information from the AP (e.g., second network apparatus 100-2), may compare the AP_OBSSID with the BSSID of the OBSS that it determined to overlap with the primary channel, and switch to the alternative primary channel based on the comparison. For example, the first network apparatus 100-1 may compare the first identifier (non_AP_STA_OBSSID) with the second identifier (AP_OBSSID).

For example, referring still to FIG. 12, at operation S1220, the STA (e.g., first network apparatus 100-1) may detect and/or decode first packets received on the primary channel. In some example embodiments, the STA (e.g., first network apparatus 100-1) may determine the first information about the first packets. The first information may include at least a first identifier of the first packets and a first duration of time for which the first packets will overlap the primary channel.

At operation S1240, the STA (e.g., first network apparatus 100-1) may switch, in response to a switch event (e.g., a first switch event), to the alternative primary channel of the plurality of channels allocated to the network of the network apparatus. Alternatively, at operation S1250, the STA (e.g., first network apparatus 100-1) may switch, in response to a switch event (e.g., a second switch event), from the alternative primary channel to the primary channel of the plurality of channels.

In some example embodiments, the STA (e.g., first network apparatus 100-1) may compare the first identifier and the second identifier. In some example embodiments, if the first identifier (e.g., non_AP_STA_OBSSID) matches the second identifier (e.g., AP_OBSSID) or is the same as the second identifier (e.g., AP_OBSSID), then the STA (e.g., first network apparatus 100-1) may switch back to the primary channel at an occurrence of a switch event (e.g., a second switch event).

In some example embodiments, the switch event may be when a transmission or communication between the STA (e.g., first network apparatus 100-1) and the AP (e.g., second network apparatus 100-2) concludes and/or terminates from both sides. For example, at an end of either a transmitted or sent or received acknowledgement frame, block acknowledgement frame, or at an end of a frame in a A-MPDU or when the STA's (e.g., network apparatus 100-1 exchange with the AP (e.g., network apparatus 100-2) on the secondary alternative channel concludes. Alternatively, in some example embodiments, the switch event may be when an AP_OBSS_Basic_NAV_Timer expires, which may be equal to the non_AP_STA_OBSS_Basic_NAV_Timer, which indicates that the Basic NAV timer information of the OBSS overlapping with the primary channel that the STA (e.g., network apparatus 100-1) was able to retrieve on its own.

In some example embodiments, the STA (e.g., network apparatus 100-1) may compare the first identifier and the second identifier. In some example embodiments, if the second identifier (e.g., AP_OBSSID) is different than or does not match the first identifier (non_AP_STA_OBSSID), then the STA (e.g., network apparatus 100-1) may switch back to the primary channel at an occurrence of the switch event.

For example, the switch event may be when a transmission with the AP (e.g., network apparatus 100-2) occurring on the alternative primary channel concludes/terminates from both sides, or when the AP_OBSS_Basic_NAV_Timer expires, or whichever of the two occurs first.

According to some example embodiments, the STA (e.g., network apparatus 100-1) may receive the information from the AP (e.g., network apparatus 100-2), may compare the first identifier and the second identifier, and switch back to the primary channel at an occurrence of a switch event. For example, if the second identifier (e.g., AP_OBSSID) matches or is a same as the first identifier (e.g., non_AP_STA_OBSSID), then the STA (e.g., network apparatus 100-1) may switch back to the primary channel as soon as the switch event occurs. Here, for example, the switch event may be when a duration of the OBSS transmission (e.g., non_AP_STA_OBSS_Basic_NAV_Timer detected by the STA (e.g., network apparatus 100-1) ends or expires.

In some example embodiments, if the second identifier (e.g., AP_OBSSID) does not match, or is different than, the first identifier (e.g., non_AP_STA_OBSSID), then the STA (e.g., network apparatus 100-1) may switch back to the primary channel as soon as the switch event occurs. Here, for example, the switch event may be when a duration of the OBSS transmission (e.g., AP_OBSS_Basic_NAV_Timer) detected by the AP (e.g., network apparatus 100-2) ends or expires.

According to some example embodiments, in addition to the AP (e.g., network apparatus 100-2) conveying, transmitting, or sending to the STA (e.g., network apparatus 100-1) information about an identifier of the OBSS detected by the AP (e.g., network apparatus 100-2) and a duration of the OBSS transmission, the STA (e.g., network apparatus 100-1) may convey the identifier of the OBSS detected by the STA (e.g., network apparatus 100-1) and the duration of the OBSS transmission detected by the STA (e.g., network apparatus 100-1) to the AP (e.g., network apparatus 100-2). In some example embodiments, the AP may update the AP_STA_OBSS_Basic NAV based on this information.

For example, this information may be carried within a dedicated information element or field information inside a control frame such as an enhanced CTS or other existing or new dedicated frames or as part of the data transmission carried in a UHR PPDU transmitted or sent by the STA (e.g., network apparatus 100-1).

Accordingly, in some example embodiments, the AP (e.g., the network apparatus 100-2) may perform the same, or substantially the same, switching operations (e.g., switching from the primary channel to the alternative primary channel, and switching from the alternative primary channel back to the primary channel) as the STA (e.g., the network apparatus 100-1).

Furthermore, in some example embodiments, the STA (e.g., network apparatus 100-1), which has switched to the alternative primary channel in response to detecting an OBSS transmission (e.g., packets from a different STA or AP that may not be a part of the reference STA or AP's network) overlapping over the primary channel and meeting some of the criteria disclosed above, may switch back from the alternative primary channel to the primary channel at a completion of a data exchange with the STA's (e.g., network apparatus 100-1) associated AP (e.g., network apparatus 100-2) or after completion of peer-to-peer communication with another STA. For example, the STA (e.g., network apparatus 100-1) may switch back from the alternative primary channel to the primary channel at an end of either a transmitted or sent or received acknowledgement (ACK) frame or block acknowledgement (BA) or at an end of a frame in A-MPDU. The STA (e.g., network apparatus 100-1) may switch back from the alternative primary channel to the primary channel irrespective of the basic NAV timer retrieved by decoding a PPDU from an OBSS in the primary channel, which may have led the STA (e.g., network apparatus 100-1) to switch to the alternative primary channel. In other words, in some example embodiments, the assessment on whether to switch to the alternative primary channel is done separately for any subsequent transmissions either inside or outside a TXOP.

According to some example embodiments, the AP (e.g., network apparatus 100-2) may advertise the switch from the alternative primary channel to the primary channel by transmitting or sending to the STA (e.g., network apparatus 100-1) a switching alternative primary channel announcement frame (e.g., a switching NPCA channel announcement frame). In some example embodiments, the switching alternative primary channel announcement frame may include at least an Element ID, a Channel Switch Mode, Selected Alternative Primary Channel, and a Time Reference for Switching. The Element ID may be a field that identifies the frame as a Channel Switch Announcement Frame. The Channel Switch Mode may be a field that indicates information on whether to switch channels and when this field is set, for example, to “1” the associated STA (e.g., network apparatus 100-1) may switch back to the primary channel when the announcement is received or based upon the Time Reference for Switching field. The Time Reference for Switching may be a field that indicates to the STA (e.g., network apparatus 100-1), when the Channel Switch Mode is set to “1”, when the switching back to the primary channel should take place. In some example embodiments, this could be associated with a timer that starts upon reception of this frame and upon expiration triggers the associated STA (e.g., network apparatus 100-1) to switch to the primary channel.

For example, upon reception of the Channel Switch Announcement frame by an STA (e.g., network apparatus 100-1) associated with the AP (e.g., network apparatus 100-2), such announcement frame triggers switching from the alternative primary channel to a primary channel (e.g., a reference primary channel) regardless of whether the STA (e.g., network apparatus 100-1) is performing a trigger-based or non-trigger based transmission with the associated AP (e.g., network apparatus 100-2).

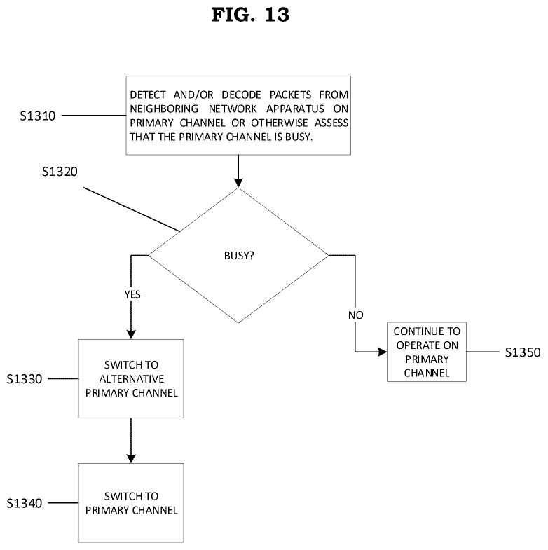

FIG. 13 illustrates a method of switching to an alternative primary channel from a primary channel according to some example embodiments.

Referring to FIG. 13, at operation S1310, a network apparatus 100-1 may detect and/or decode packets received on the primary channel of the plurality of channels allocated to the network of the network apparatus 100-1. At operation S1320, the network apparatus 100-1 may determine that the primary channel is busy in response to the detection and/or the decoding. At operation S1330, the network apparatus 100-1 may switch to the alternative primary channel and at operation S1340, the network apparatus 100-1 may switch back to the primary channel. In some example embodiments, at operation S1350, if the network apparatus 100-1 determines that the primary channel is not busy, the network apparatus 100-1 may continue to operate on the primary channel.

In some example embodiments, when a STA (e.g., network apparatus 100-1) has switched to the alternative primary channel in response to detecting and/or assessing that the primary channel is busy, but the STA (e.g., network apparatus 100-1) was not able to perform decoding on that channel, was not able to retrieve basic NAV information, and was not able to retrieve the information about a length or duration of the OBSS transmission from other sources, the STA (e.g., network apparatus 100-1) may switch back to the primary channel based on the following conditions (e.g., switch events) described further below.

For example, the STA (e.g., network apparatus 100-1) may switch back from the alternative primary channel to the reference primary channel at an end of the TXOP where the transmission on the alternative primary channel has started. For example, the STA (e.g., network apparatus 100-1) may switch back from the alternative primary channel to the primary channel at a completion of a data exchange (e.g., at an end of either a transmitted or sent or received ACK frame, block acknowledgement, or at an end of a frame in A-MPDU) that has started in the alternative primary channel. For example, the STA (e.g., network apparatus 100-1 may switch back from the alternative primary channel to the primary channel after a switching alternative primary channel announcement is transmitted by an AP (e.g., network apparatus 100-2) or is received by an associated STA (e.g., network apparatus 100-1) as described further above according to some example embodiments.

In some example embodiments, the STA (e.g., network apparatus 100-1 or network apparatus 100-2) may switch back from the alternative primary channel to the primary channel according to any of the above described example embodiments. For example, if the STA (e.g., network apparatus 100-1 or network apparatus 100-2) that is not able to retrieve the basic NAV information is an associated non-AP STA (e.g., network apparatus 100-1), the STA (e.g., network apparatus 100-1) would follow the same switching criteria as the AP (e.g., network apparatus 100-2) and assumes that AP_OBSSID=non_AP_STA_OBSSID. For example, if the STA that was not able to retrieve the basic NAV information is the AP (e.g., network apparatus 100-2), the AP (e.g., network apparatus 100-2) may set AP_OBSSID to a predefined, or alternatively desired value and may set AP_OBSS_Basic_NAV_Timer using at least one of a plurality of options. For example, a first option may be to set the AP_OBSS_Basic_NAV_Timer to expire at an end of the TXOP where the transmission on the alternative primary channel has started. For example, a second option may be to set AP_OBSS_Basic_NAV_Timer to expire at the end of the completion of a data exchange (e.g., which is at an end of either a transmitted or received ACK frame or block acknowledgement (BA) or end of frame in A-MPDU) with the associated STA (e.g., network apparatus 100-1).

In some example embodiments, the switch back from the alternative primary channel to the primary channel occurs as described in any of the above described example embodiments. For example, if the network apparatus that was not able to retrieve the basic NAV information is a non-AP STA (e.g., network apparatus 100-1), the STA may set non_AP_STA_OBSSID to a predefined value and may set non_AP_STA_OBSS_Basic_NAV_Timer to expire at an end of the TXOP where the transmission on the alternative primary channel has started, or at an end of the completion of a data exchange with the associated AP (e.g., network apparatus 100-2).

In some example embodiments, if the network apparatus that was not able to retrieve the basic NAV information is the AP (e.g., network apparatus 100-2), the AP may set AP_OBSSID with a predefined value and may set AP_OBSS_Basic_NAV_Timer to an end of the TXOP where the transmission on the alternative primary channel has started, or may set it to expire upon completion of all data exchanges with all associated non-AP STAs on the alternative primary channel.

In some example embodiments, when a non-AP STA (e.g., network apparatus 100-1) has switched to the alternative primary channel as a consequence of finding the primary channel busy, but was not able to perform on that channel and retrieve the basic NAV information, but is aware of the length of the transmission that is overlapping on the primary channel and that triggered the switch to the alternative primary channel (e.g., in a case when an in-device technology, e.g., Bluetooth, transmission overlaps with the primary channel and the length of this transmission is provided to an 802.11 module through an interface with that technology) and the STA was able to establish communication with the associated AP (e.g., network apparatus 100-2) which instead has switched channels because of an OBSS transmission, the STA (e.g., network apparatus 100-1) may switch back to the primary channel based on the following conditions: The switch back from the alternative primary channel to the primary channel occurs at an end of the TXOP where the transmission on the alternative primary channel has started; the switch back from the alternative primary channel to the primary channel occurs at the completion of a data exchange (e.g., which is at an end of either a transmitted or received ACK frame or Block Acknowledgement or end of frame in A-MPDU) that has started in the alternative primary channel; or the switch back from the alternative primary channel to the reference primary channel occurs only after a switching alternative primary channel announcement is transmitted by the AP (e.g., network apparatus 100-2) or is received by an associated STA (e.g., network apparatus 100-1), but example embodiments are not limited thereto. For example, the switch back to the alternative primary channel to the primary channel may occur soon after the end of the transmission that was overlapping with the primary channel for which the STA is aware of the length.

According to some example embodiments, when a non-AP STA (e.g., network apparatus 100-1) has switched to the alternative primary channel as a consequence of finding the primary channel busy, but was not able to perform on that channel and retrieve the basic NAV information, but the STA is also not aware of the length of the transmission that is overlapping on the primary channel, and that triggered the switch to the alternative primary channel (e.g., when an in-device technology, e.g., Bluetooth, transmission overlaps with the primary channel and a length of this transmission is not provided to the 802.11 module through an interface with that technology) and the STA was able to establish communication with the associated AP (e.g., network apparatus 100-2) which instead has switched because of an OBSS transmission, the STA may switch back to the primary channel based on the following switch events/conditions. The switch back from the alternative primary channel to the reference primary channel may occur at an end of a TXOP where the transmission on the alternative primary channel has started. The switch back from the alternative primary channel to the primary channel may occur at a completion of a data exchange between both network apparatuses 100-1 and 100-2 (e.g., which is at an end of either a transmitted or received ACK frame or block acknowledgement (BA) or end of frame in A-MPDU) that has started in the alternative primary channel. The switch back from the alternative primary channel to the reference primary channel occurs only after a switching alternative primary channel announcement is transmitted by an AP or received by an associated non-AP STA. According to some example embodiments, the switch back may occur according to any of the above described procedures and/or operations.

According to some example embodiments, when a non-AP STA (e.g., network apparatus 100-1) has switched to the alternative primary channel as a consequence of finding the primary channel busy, but was not able to perform on that channel and retrieve the basic NAV information (for example, when an in-device technology (e.g., Bluetooth) transmission overlaps with the primary channel) and the STA was able to establish communication with the associated AP which instead has switched because of an incumbent transmission, either AP and non-AP STA can switch back to the primary channel by combining any of the above described methods, operations, or steps.

According to some example embodiments, when a non-AP STA (e.g., network apparatus 100-1) has switched to the alternative primary channel as a consequence of finding the primary channel busy, but was not able to perform on that channel and retrieve the basic NAV information, but the STA was aware of a length of the transmission that is overlapping on the primary channel and that triggered the switch to the alternative primary channel (for example, when an in-device technology (e.g., Bluetooth) transmission overlaps with the primary channel) and the STA was not able to establish communication with an associated AP (e.g., network apparatus 100-2), the STA may switch back to the primary channel at an end of a transmission that led to the non-AP STA to switch to the alternative primary channel.

According to some example embodiments, when a non-AP STA has switched to the alternative primary channel as a consequence of finding the primary channel busy, but was not able to perform on that channel and retrieve the basic NAV information, is not aware of the length of the transmission that is overlapping on the primary channel, and that triggered the switch to the alternative primary channel (for example, when an in-device technology (e.g., Bluetooth) transmission overlaps with the primary channel), and was not able to establish communication with an associated AP, the STA may switch back to the primary channel as soon as possible.

While a number of example embodiments have been disclosed herein, it should be understood that other variations may be possible. Such variations are not to be regarded as a departure from the spirit and scope of the present inventive concepts, and all such modifications as would be obvious to one skilled in the art are intended to be included within the scope of the following claims.

Although described with reference to specific examples and drawings, modifications, additions and substitutions of example embodiment may be variously made according to the description by those of ordinary skill in the art. For example, the described techniques may be performed in an order different with that of the methods described, and/or elements such as the described system, architecture, devices, circuit, and the like, may be connected or combined to be different from the above-described methods, or results may be appropriately achieved by other elements or equivalents.

What is claimed is:

1. A network apparatus for switching between a primary channel and an alternative primary channel of a plurality of channels allocated to a network of the network apparatus, comprising:
at least one processor; and
at least one memory configured to store computer program code, the at least one processor, when executing the computer program code, is configured to cause the network apparatus to,
detect and decode packets received on the primary channel of the plurality of channels allocated to the network of the network apparatus;
determine that the primary channel is busy in response to the detection and the decoding; and
switch, in response to a switch event, to the alternative primary channel of the plurality of channels.

2. The network apparatus of claim 1, wherein the switch event occurs in response to detecting a packet received on the primary channel and determining that decoding of the received packet is not possible.

3. The network apparatus of claim 1, wherein
the at least one processor is configured to cause the network apparatus to detect a packet received on the primary channel and decode the received packet; and
the switch event occurs subsequent to the decoding of the received packet or in response to a determination that the received packet is from a separate network or a separate network apparatus.

4. The network apparatus of claim 1, wherein the at least one processor is configured to cause the network apparatus to,
detect and decode a packet received on the primary channel;
determine whether the received packet includes an indication of a duration for which the primary channel is reserved for the packets received on the primary channel; and
switch, in response to the switch event, to the alternative primary channel for the duration, the switch event occurring in response to the determination that the received packet includes the indication of the duration, or
switch, in response to the switch event, to the alternative primary channel, the switch event occurring in response to the determination that the received packet does not include the indication of the duration and at an end of the received packet.

5. The network apparatus of claim 1, wherein the at least one processor is configured to cause the network apparatus to detect and decode a packet received on the primary channel, and the switch event occurs at an end of the received packet or after receiving an aggregated packet portion.

6. The network apparatus of claim 1, wherein, the at least one processor is configured to cause the network apparatus to detect and decode a packet received on the primary channel and determine whether the received packet includes an indication of a duration for which the primary channel is reserved for the packets received on the primary channel, and the switch event occurs,
after the duration;
after a control frame exchange; or
after receiving a first aggregated data packet.

7. The network apparatus of claim 1, wherein the at least one processor is configured to cause the network apparatus to, in response to detecting that the primary channel is busy, switch to the alternative primary channel in response to the switch event occurring, the switch event occurring
in response to a determination that the network apparatus has utilized the primary channel for at least one second, or
in response to a determination that a received packet overlaps with the primary channel, a duration for which the primary channel is reserved for the packets received on the primary channel is available, and the duration is shorter than a value.

8. A first network apparatus for switching between a primary channel and an alternative primary channel of a plurality of channels allocated to a network of the first network apparatus, comprising:
at least one processor; and
at least one memory configured to store computer program code, the at least one processor, when executing computer program code, is configured to cause the first network apparatus to,
communicate with a second network apparatus;
detect and decode first packets received on the primary channel of the plurality of channels allocated to the network of the first network apparatus;
determine first information of the first packets, the first information including at least a first identifier of the first packets and a first duration of time for which the first packets will overlap with the primary channel;
receive, from the second network apparatus, second information of second packets received on the primary channel, the second information including at least a second identifier of the second packets and a second duration of time for which the second packets will overlap with the primary channel; and
switch, in response to a first switch event, from the alternative primary channel to the primary channel of the plurality of channels.

9. The first network apparatus of claim 8, wherein the first switch event occurs based on the first identifier and the second identifier.

10. The first network apparatus of claim 8, wherein the at least one processor is configured to cause the first network apparatus to send the first information to the second network apparatus, and the first switch event occurs in response to the first identifier matching the second identifier, and subsequent to,
the communication with the second network apparatus concluding,
the first duration or the second duration expiring, or
the communication with the second network apparatus concluding or the first duration or the second duration expiring, whichever occurs first.

11. The first network apparatus of claim 8, wherein the first switch event occurs in response to the first identifier being different than the second identifier, and subsequent to,
the communication with the second network apparatus concluding,
the first duration or the second duration expiring, or
the communication with the second network apparatus concluding or the first duration or the second duration expiring, whichever occurs first.

12. The first network apparatus of claim 8, wherein the first switch event occurs,
in response to the first identifier matching the second identifier and subsequent to the first duration or the second duration expiring; or
in response to the first identifier being different than the second identifier and subsequent to both the first duration and the second duration expiring.

13. The first network apparatus of claim 8, wherein the first switch event occurs in response to the detecting of the second packets and at a completion of a data exchange with the second network apparatus.

14. The first network apparatus of claim 8, wherein the at least one processor is configured to cause the first network apparatus to receive from the second network apparatus an announcement frame, the announcement frame including at least,
an element identifier identifying the announcement frame as a switching announcement frame; and
a channel switch field indicating a switch to the primary channel or the alternative primary channel.

15. The first network apparatus of claim 14, wherein the first switch event occurs based on the received announcement frame.

16. A first network apparatus for switching between a primary channel and an alternative channel of a plurality of channels allocated to a network of the first network apparatus, comprising:
at least one processor; and
at least one memory configured to store computer program code, the at least one processor, when executing computer program code, is configured to cause the first network apparatus to,
detect packets received on the primary channel of the plurality of channels allocated to the network of the first network apparatus;
determine that the primary channel is busy in response to the detection;
determine that decoding of a packet received on the primary channel is not possible;
and
switch, in response to a first switch event, from the alternative primary channel to the primary channel of the plurality of channels.

17. The first network apparatus of claim 16, wherein the first switch event occurs in response to,
a duration for which the packets will overlap with the primary channel ending and a duration for which the packets will overlap with the alternative primary channel beginning;
a completion of a data exchange on the alternative primary channel; or
receiving an announcement frame from a second network apparatus.

18. The first network apparatus of claim 16, wherein the first switch event occurs in response to,
detecting a duration for which the packets will overlap with the primary channel; and
establishing communication with a second network apparatus, the second network apparatus having switched to the alternative primary channel.

19. The first network apparatus of claim 16, wherein the first switch event occurs in response to,
determining that the detecting a duration for which the packets will overlap with the primary channel is not possible and that the decoding of a packet received on the primary channel is not possible; and
continuing communication with a second network apparatus.

20. The first network apparatus of claim 16, wherein the second switch event occurs in response to,
detecting a duration for which the packets will overlap with the primary channel;
determining that decoding of a packet received on the primary channel is not possible;
determining that communication with a second network apparatus is not possible; and
a transmission of the first network apparatus ending.
